(19) United States
(12) Patent Application Publication
(10) Pub. No.: US 2016/0025197 A1
(43) Pub. Date: Jan. 28, 2016

(54) An inescapable path to transform a form of motion

(71) Applicant: József GULYAS, Miskolc (HU)

(72) Inventor: József Gulyas, Miskolc (HU)

(21) Appl. No.: 14/367,928

(22) PCT Filed: Dec. 21, 2012
(86) PCT No.: PCT/HU2012/000140

§ 371 Date: Jun. 22, 2014

(30) Foreign Application Priority Data
Dec. 22, 2011 (HU) P1100710
Dec. 21, 2012 (HU) P1200761

(51) Int. Cl. F16H 25/12

(52) U.S. Cl. CPC F16H 25/122

(57) ABSTRACT

The invention is a movement transformation device, mechanism and driving gear that consists of a rotation part, a tool that works with a two-way straight line alternating movement, power transmission parts and units that make sure that the power transmission parts stay in position. The inescapable path that has double control and can be established optionally is a form together with the power transmission units in it that are also responsible for direction. The device can be connected to a rotor by an axis-like tool. The rotation of the tool making alternating movement, its rotation movement there and back and its lubrication can be executed upon demand. When the friction factor is smaller, a fixed sliding bush may be satisfactory, in which the two-way movement takes place. Under greater stress balls may be inserted into the fixed sliding bush in order to minimize friction factors. The invention may be used with any machine, equipment, tool or area, where forms of motion need transformation.

The invention is a movement transformation device mechanism and driving gear that consists of a rotor, a tool that moves two ways in alternating straight line, power transmission units and a unit thai makes sure that the power transmission units stay in position. The wanted rotor is connected to the engine rotor. This can be an infernal axis-like tool and can be an external case-like tool. An inescapable path is created from optional radiuses, curves, and straight lines into the external diameter of the axis-like tool. A case-like tool is to be found of the latter tool's external diameter that will carry out the alternating movement. It will carry out the two way straight line movement in the axial direction, i.e. respecting the centre line and the axis of symmetry of the engine's drive with the assistance of the created inescapable path and the power transmission units that it contains. The stroke and the speed within can be modified by changing the path's size and shape. The rotation of the tool making alternating movement its rotation movement there and back end its lubrication pan be executed upon demand. When the friction factor is smaller, a fixed sliding bush, grease, oil film may be satisfactory, in which the two-way movement takes place. Under greater stress balls may be inserted into the fixed sliding bush in order to minimize friction factors. The shape of the inescapable path can also be optimized by the necessary momentum revolutions per minute, stroke and other parameters. The device may be operated in a closed system, thus in an insulated container that provides permanent lubrication.

Its operational areas are all piston-system compressors produced by swivel mechanisms or all known piston, ex-centre or movement transformation systems. Beyond these, the invention can he applied everywhere, where straight line alternating movement is necessary, where a rotation movement is given, or a rotation movement is required and such can be transformed from straight line movement. Movement transformation mechanisms are familiar to us, but the majority of those are radial direction ones. The conventional swivel mechanism as well as ex-centre solutions are like this, the majority of those are also created by radial direction. L this invention aims to use the inescapable path in a way that has not been known so far.

Let us present a three-dimensional, laid, axial direction eight, an [infinity] shape with a minimum of two power transmission and control units. No compressor or any axial direction piston system, hand tools, small machines requiring a relatively short stroke or machines with a large stroke are known to us that would be produced and sold with this solution.

Considering state of the art technology the closest solutions are the following:

patent no. Ep 1 072 823 at no. 00401722.4 (year 2001)

this inescapable path mechanism aims e.g. To put the transmission cogwheels into a new position by turning away lees than 360 degrees at a time. Furthermore, the inescapable path construction and its structure is different from the mechanism we have designed and it is not able to provide alternating movement due to high revolutions per minute and is also functionally different from our invention. This solution is not able to operate continually making thousands of revolutions per minute.

U.S. Pat. No. 3,792,616, appl. no: 330,280 (year 1974)

the invention claims that it is a favourable construction with a majority needle bearing solution. In this invention there are essentially two power transmission units with eight needle bearings and two separate paths that are perpendicularly located against the axle direction and two pegs with cone-shaped jointings that will transmit power by one-sided loading perpendicularly against the axle in a way that needle bearings are also used at non-denned sports at both ends of the axle. This is a great difference compared to our invention, because the mechanism we presented transmits momentum on two double-controlled paths against each other that are shifted from each other, balancing radial powers. Since the invention mentions the scale of cone-shaped jointing in the inescapable path and as a result the needle bearings on the two side axles must tolerate support stress, in this case this is a critical cross-section. According to the invention drawing it might be another problem that the needle bearing is only able to concurs optimal defies on its own axle, however, the drawing suggests that the needle bearings follow the constructed inescapable path, thus the unit designed for this purpose must not only rotate, but also has to perform a sliding movement compared to its own axle. Such a mechanism limits both the revolutions per minute and the stroke speed and the construction's lifespan might be short in an open and dry state, while such a mistake is avoided by our invention, as it provides a closed system use. A further key issue is that the above mentioned invention's power transmission unit rotates compared to its own axle when power is transmitted directly, while ours performs this by a rolling movement. As another difference is to be noted that the above mentioned invention has two pegs and bearings, thus the external case is not able to rotate and make a high number of revolutions per minute without the inertial power of the masses, while our invention can rotate the case-like tool upon request and the alternating movement will be provided by the axle-like tool.

Ultimately, this inescapable path mechanism does not present any concrete tasks or solutions to them.

United states 428,410 patent, no. 6123/34 (year 1935)

this invention presents several separate, two-unit inescapable paths with reverse angular offsets. An essential difference is that the required main work is not performed by the inescapable path directly, but it is created by another mechanism on the symmetry axle that is not identical with the axle of the inescapable path. The pistons are on another axle line here. Further key difference is that the above mentioned invention is not able to operate in the reverse construction structure, where the external case would rotate. Our invention performs this on the same symmetry axle, thus the inescapable path and the tool performing the alternate movement on it can be characterised in this solution as the inescapable path and the piston sharing the same axle.

United kingdom 114,317 patent, no. 51 14/18 (year 1917)

this invention is a movement transformation construction that forces the axle-like tool to rotate that was created by the inescapable path between two units, parallel with the axle of the inescapable path, but with a time shift. The side direction loading will balance itself only in the medium position of the stroke and the invention is not able to operate with a high number of revelations per minute in other positions due to side forces and friction factors. An important difference is that in case of our invention the major work performance, the axle-like tool created by inescapable path and the piston fall in the same axis line, thus both the piston arid the rotation fall on the same symmetry axle.

A so far unresolved problem of swivel mechanism is the abrasion due to “scourging movement”, after which the piston will lose its original size on primarily two opposite sides and will begin to wear out. In the construction we present this is not apparent at all, because the driving is located in the direction of the axle and this makes the abrasion take place evenly in a 360 degree angle, which caused much less abrasion than in conventional systems.

A problem source of ex-centre solutions can be that the level of resonance is too high. Some inventions have already solved this by constructing an additional ex-centre into it which balances the resonance caused by the powers of masses of high revolutions per minute.

Axial rolling drive can also reduce this problem.

As far as we know, an inescapable path exists, but we have no information on whether any production or sale has indeed happened based on our invention description.

The task to be solved is to cut the mistakes of systems known and used so far, to minimise the level of resonance that may be harmful to health, to reduce production costs and to enhance the construction's lifespan.

Our invention may be applied for this purpose on short and long stroke equipment and machines. A short stroke could be called the ex-centre solution of the present production method of a hedge cutting machine. Due to a hedge cutting machine's ex-centre mechanism, it was equipped with radial driving, which led to relatively many internal units and the engine had to make a high number of revolutions per minute because of transmissions in order to reach the required stroke speed and momentum.

Instead of the present solution our invention suggests that the engine should be connected with the axle with an inescapable path, onto which the case-like tool making alternate movement is fit, then it is fixed against turning away and it directly connected to the hedge cutting knife that performs the main job. In order to get to this point the past of the rotating axle that is further away from the engine is equipped with bearings and the machine will be operable.

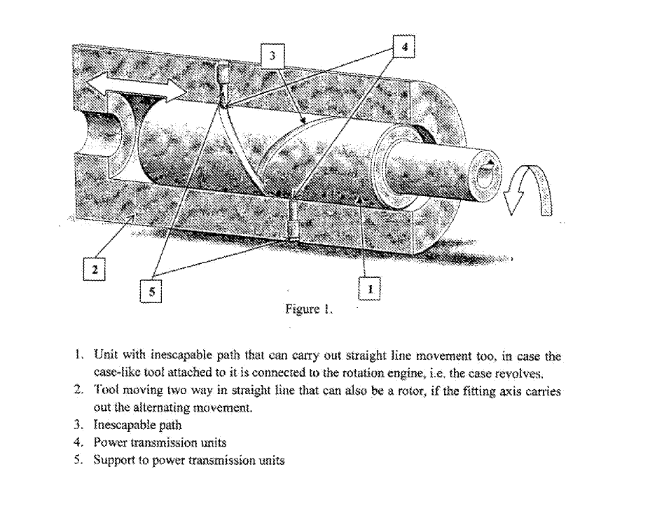

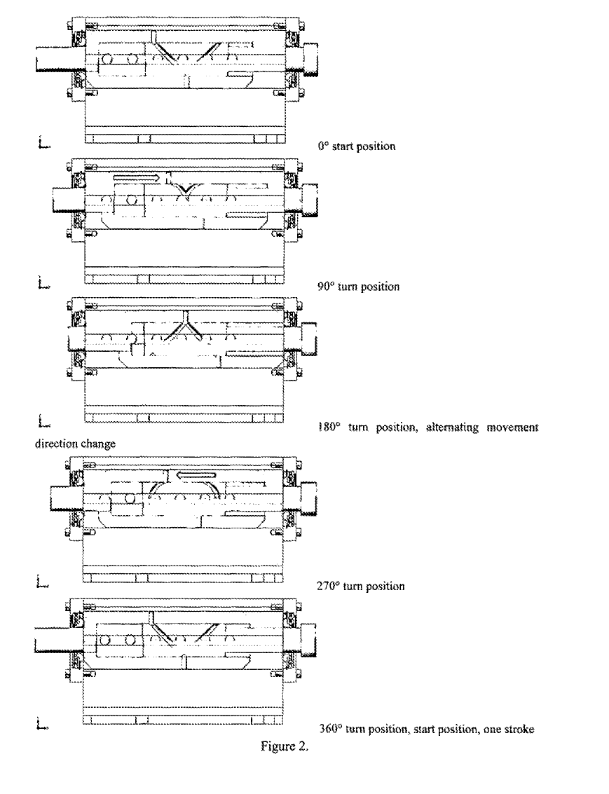

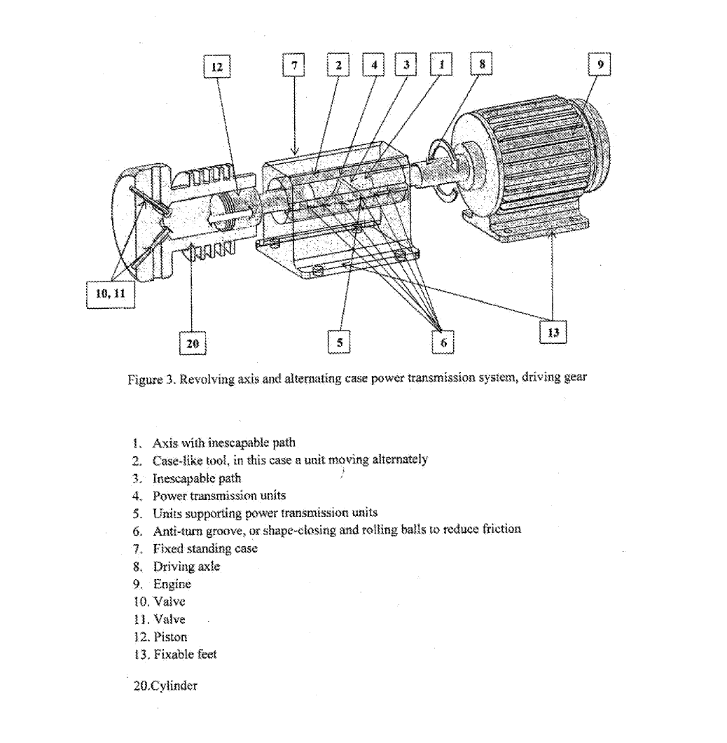

FIG. 1. Describes the major units of the construction in the points of claim.

Our solution makes the production of the machine easier, the number of tools will be cut, the revolutions per minute the engine performs can be reduced, and within the number of revolutions per minute even the stroke speed can be modified in any direction by shaping the inescapable path. The opportunity of tailor-made development to reach optimal result to available. The internal structure and the operational mechanism of the machine will be changed. The construction has been simplified, its structure or function has not changed, its quality has not deteriorated.

This means that it can be produced more cost-effectively also keeping the same quality.

That is how the task of our invention was not only justified in theory, but also in practice. The invention idea, though very simple, was the following: the basis was a moving transformation system that has never been used among the above mentioned systems, but rather already existing systems have been developed, traditions were followed and the chance of an innovation from scratched was overlooked.

We have realised that such an innovation can function in proper appliance areas depending on the shaping of the inescapable path as well as the driving's number of revolutions per minute and momentum. These, however, can be optimised and produced more cost-affectively also keeping the same quality.

Among others the innovation's major advantage is that it consists of four key parts, thus it enables the user to reach the very goals set by optimisation and development and it is much easier to coordinate such a minimal number of units in order to solve the duty ahead than before. Conventional constructions certainly have the disadvantage against our invention that they consist of more parts, have more connection points and their development opportunities are less available than of this invention.

Another favourable option is to construct our invention into an axial direction piston compressor. Even the most popular cooling and air conditioning compressors are based on the traditional swivel piston mechanism principle. As we believe, axial driving would again ensure more economic operation for cross direction driving and transmission including the production of a construction with more parts. Having fewer parts and units means lower chances for a mistake. Our invention presents a bearing system move in harmony with the direction of the engine and driving and as a result of this it works by less resonance and noise.

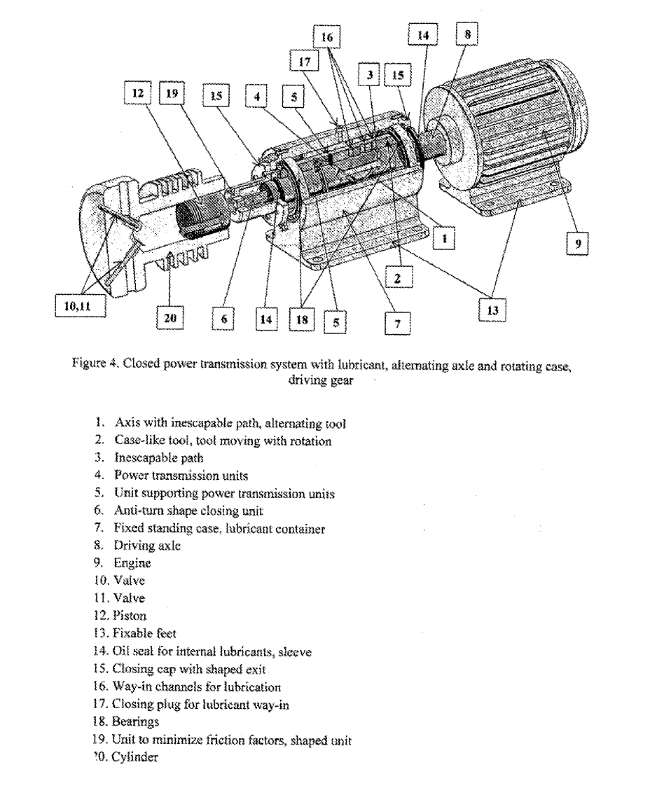

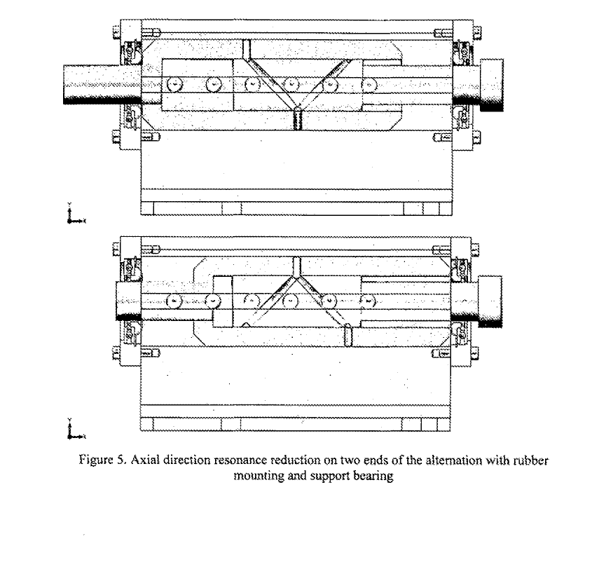

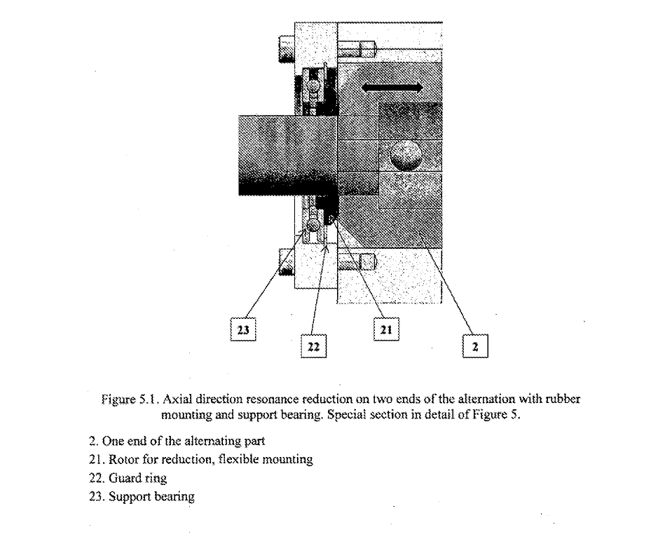

Exactly this solution is presented at FIG. 4. Movement transformation here is determined by the required connected tool inside the construction within a rotation driving. The rotation or alternating movement can be performed by both the axle-like tool no. 1 and the case-like tool no. 2. In such a case the case-like tool no. 2 is connected to the axle of the engine no. 9 and the axle-like tool no. 1 will perform the alternating move. The axle-like tool has an inescapable path no. 3 and the positioning of the power transmission tools no. 4 as well as the support tools no. 5 fix the transmission of the engine's, no. 9, rotation and its reformation into alternating movement. The driving takes place in the same direction with its symmetry axle with the inclusion of rolling power transmission units no. 4 and a construction that blocks the turn of part no. 6 performing alternate move. Its gliding surface can be self-lubricant with friction bearing, ball rolling alternate move. no. 19. Based on the use area's demands the construction may operate with partial lubrication or friction reduction, or in a closed system, where friction factors are continually minimised by proper lubricants and closed by a closing cap no. 15. This must happen with the inclusion of stability bearings no. 18 and units no. 21 that can reduce or mitigate the axial direction inertial power of the masses that arise at two ends of the alternate move, when directions are changed. The reduction is to be performed by the background inclusion of a thrust bearing no. 23. That will not block rotation. The shape of inescapable path no. 3 and the parts material will be designed on the basis of heat and surface treatment, revolutions per minute and stroke speed, just like in the case of rolling power transmission units no. 4 including the replaceable inlay no. 24 that is in direct connection with our power transmission unit. The piston no. 12 will perform the alternating movement from the rotation in the cylinder no. 20, in the case presented here the air will be carried and condensed.

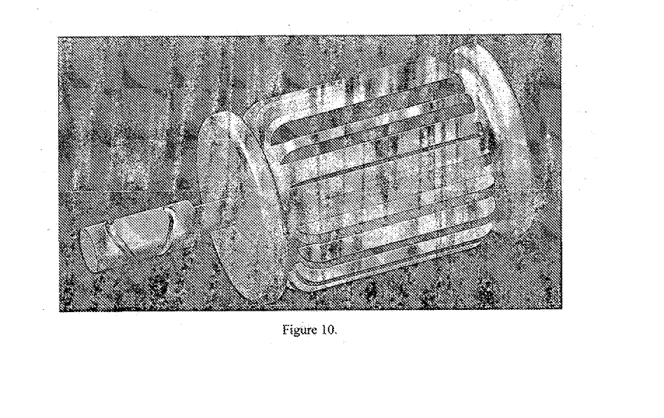

FIG. 10. Will present how the production costs of another tool could be reduced. As for mass production, the engine may be prepared in a way that the inescapable path required by stroke is already established on its axle. After this innovation only the case-like tool, the power transmission units and the units necessary for its positioning must be attached to the engine axle to get alternating movement. To put this simply, with the extension of the few parts listed before, the engine can produce alternating movement with the help of the case attached to it. The part connected to the case is already the device that performs the main job.

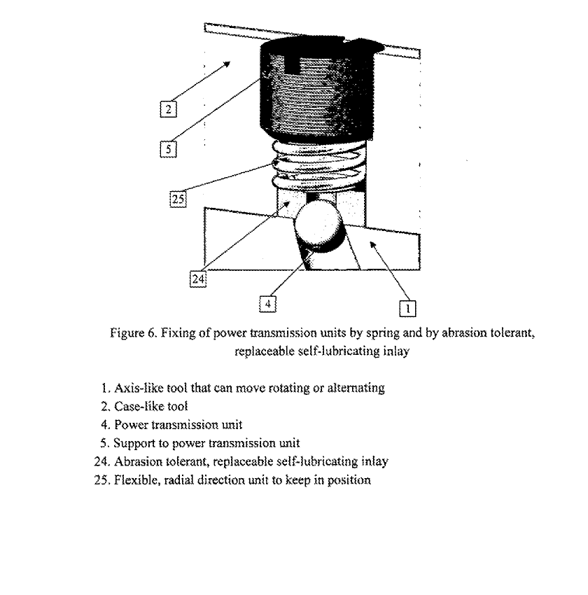

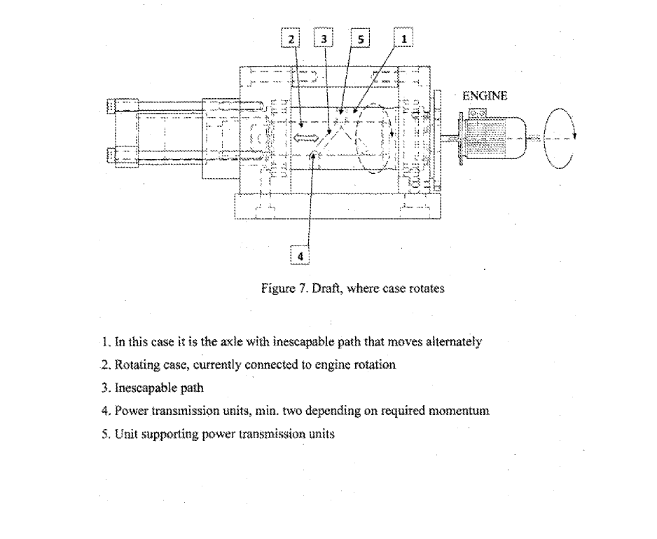

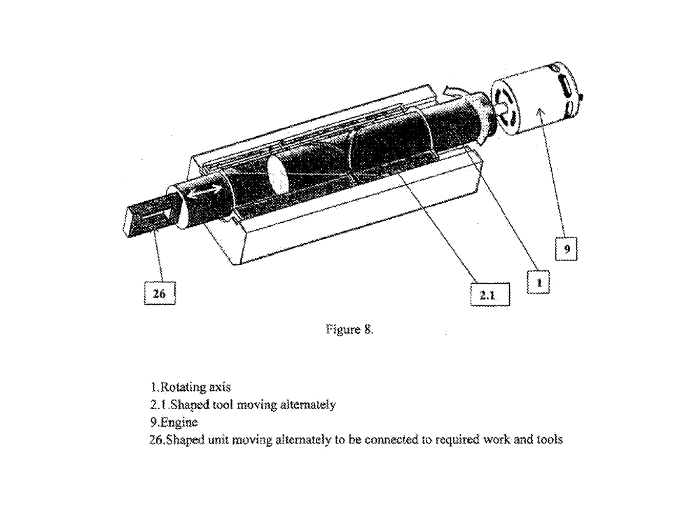

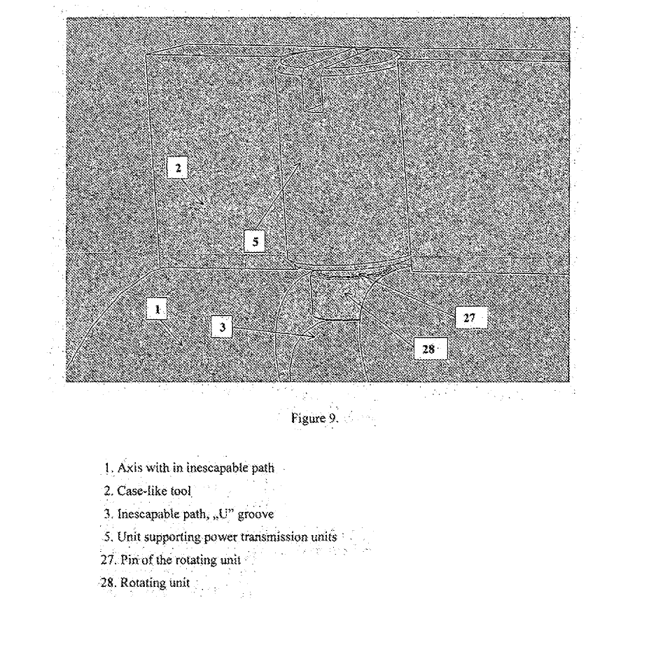

FIG. 9. Shows that in case a strong power transmission is required, the momentum can be transmitted by any unit of the bearings. The inescapable path here makes a “u”-shaped groove form, the bearing fits into this.

If straight line movement is available, the construction is able to transform it into rotation. A primary idea for this is sea currents, where the construction with an optimal inescapable path is able in do this and it is also able to serve the needs of new and innovative energy use end production. The utilisation area of our invention is wide, constructions like looks moving there and back could be among such, e.g. Cars' central locks, where the lock may be opened or closed with the help of one-direction, sectional rotation of a servomotor, an actual step motor and it creates a safe situation, when it's closed, because it closes automatically, thus the construction can only open or close with rotation. In this case the look's complexity is reduced, also keeping safe operation at the same time.

The invention is to be used in a wide range of areas from step motor through low revolutions per minute to extreme high revolutions per minute, because the coordination of power transmission gets simpler by the direct driving.

The invention has an even more simplified version for mass production, where engines are produced with inescapable path axle, which makes alternating movement much easier.

By this solution, when production takes place with axial power transmission, less material is used, production costs can be cut, though keeping the same quality.

A further advantage of the solution is that an inescapable path is already created on the axle of the engine, driving, the rotational part of our rotation unit, thus the production of further parts is not necessary and alternating movement can be reached by the attachment of a single unit.

The production material of the construction's main units can be defined very easily, if we know what stress the construction must bear in a certain area of use. The construction's life span is actually determined by two key units, therefore material quality is selected to meet demands, friction factors get minimised, the optimal inescapable path is created on it, it will be heat and surface treated upon demand, which all lead to a well-predictable operational period.

### Utilisation Areas

1. Use of piston mechanisms

2. Use of ex-centre mechanisms

3. Any utilisation area, where rotation movement should be transformed into alternating movement, or the reverse case, when alternating movement should be transformed into rotation.

4. Production of electric, combustion and other engines

within these, some concrete product ideas.

air technology, air conditioning industrial and other compressors (fridge, freezer)
pumps
vehicle industry—e.g. Air conditioning compressors, high pressure pumps, driving transmission, differential locks
household machines—e.g. jigsaw, hedge cutter, front saw
self-starter
central safety or other looks
household appliances (the current ones only rotate, but what if those would move up and down tool?
valves
production lines, where a certain distance is to he covered there and back and no energy is consumed in calm position
target machines
production of engines, where the inescapable path is already created on the engine axle, therefore a connection unit will already make a connection to the part that performs the main job,
robot technology
+18 constructions

if straight line movement is available, rotation can be created, thus energy can he produced through a generator.
various wave power plants

energy utilisation equipment

1. An inescapable path to reform movement type, which reforms rotation into alternating movement characterised by the fact that the movement reformation for the rotation driving is determined by a required attached tool in the construction, the rotation or the alternating movement can he carried out by an axle-like tool (1) or by a case-like tool (2), an inescapable path is created on the axle-like part (3) and power transmission units (4) and units supporting power transmission (5) guarantee that the engine's (9) rotation is transmitted and alternating movement is created, driving happens in the same direction as the symmetry axle with the inclusion of rolling power transmission units (4) and an anti-turn feature of the part performing altercating movement (6), which may have a self-lubricant gliding surface or one with friction bearings or ball rolling alternating movement (19), based an the use area's demands the construction may operate with partial lubrication or with friction factor reduction or in a closed system, where friction factors are continually minimised by proper lubricants (7) and closed by a closing cap (15), this must happen with the inclusion of stability bearings (18) and units (21) that can reduce or mitigate the axial direction inertial power of the masses that arise at two ends of the alternate move, when directions are changed, the reduction is to be performed by the background inclusion of a thrust bearing (23) that will not block rotation, the shape of inescapable path (3) and the parts material will be designed on the basis of heat and surface treatment, revolutions per minute and stroke speed, just like in the case of rolling cower transmission units (4) including the replaceable inlay (24) that is in direct connection with our power transmission unit, the piston (12) will perform the alternating movement from the rotation in the cylinder (20).

2. As in point no. 1, an inescapable path to reform movement type, which reforms straight line movement into rotation characterised by the fact that the rotation may be performed by the axle-like tool (1) or the case-like tool (2) with an anti-turn construction against alternating movement (6), (2.1), as in points no. 1 and 2, an inescapable path to reform movement type characterised by the fact that rotation is connected with the external case, thus the alternating movement will be performed by the axle, in order to stop turning away a shape unit or shape closing binding is used (26) and a replaceable unit makes sure the friction factors get optimised (24).

3. As in points no. 2, an inescapable path to reform movement type characterised by the fact that the two ends of the inescapable path and the radius of change of direction are created in a self-closing way, thus only rotation can start the alternating movement and this makes the operation of locks safer.

4. As in points no. 3, an inescapable path to reform movement type characterised by the fact that the driving and the engine (9) will not carry out continuous rotation, but works in sections, in a step motor function and the alternating movement will not be produced at identical times, but upon demand.

5. As in points no. 4, an inescapable path to reform movement type characterised by the fact that the friction factors between rotation and alternating movement will be optimised by well-known materials.
